(19) United States
(12) Patent Application Publication
(10) Pub. No.: US 2026/0085692 A1
(43) Pub. Date: Mar. 26, 2026

(54) FAN LAMP WITH BLADE ARM ASSEMBLY

(71) Applicant: JOININ GLOBAL PTE. LTD., Singapore (SG)

(72) Inventor: Hongbing ZHENG, Singapore (SG)

(21) Appl. No.: 18/933,631

(22) Filed: Oct. 31, 2024

(30) Foreign Application Priority Data
Sep. 26, 2024 (CN) 202422369587.5

(51) Int. Cl. F04D 29/34; F04D 19/00; F04D 29/64; F21V 33/00

(52) U.S. Cl. CPC F04D 25/088; F04D 19/002; F04D 29/34; F21V 33/0096

(57) ABSTRACT

A fan lamp with a blade arm assembly, includes a mounting base and a connecting member that is ring-shaped and has a hollow center. A plurality of blade arms are inserted into the mounting base, and each of the plurality of blade arms is connected with a respective blade, and the connecting member and the plurality of blade arms are detachably connected with each other. Connection strength between the blade arm and the mounting base is improved through insertion of the blade arm into the mounting base, and the plurality of blade arms surrounding a periphery of the mounting base are connected together through the connecting member, so that the blade arms, the mounting base and the connecting member are combined to form a new plane, which are integrated and is more difficult to fall off with ensured connection strength.

### CROSS-REFERENCE TO RELATED APPLICATION

This Non-provisional application claims priority under 35 U.S. C. § 119(a) on Chinese Patent Application No(s). 202422369587.5 filed on Sep. 26, 2024, the entire contents of which are hereby incorporated by reference.

### TECHNICAL FIELD

The disclosure relates to related technical field of air feeding apparatuses, in particular to a fan lamp with a blade arm assembly.

### BACKGROUND ART

A general ceiling fan usually includes a motor and a plurality of blades arms located on the motor and distributed in a circular ring array, each blade arm is connected with a blade, and the motor, the blade arm and the blade are usually in a mutually detachable state.

When the ceiling fan leaves the factory, the blade arms and blades of the ceiling fan are usually stored separately from the motor in order to facilitate transportation and storage, and when mounted, they are connected fixedly, but in most cases, they are connected directly by bolts. In a case of long-term use, the blade arms are loose due to weight and inertial impact of the blades themselves, and the blade arms are easily deformed or damaged, and may even fall off, which may make the whole fan unbalanced and cause potential safety hazards.

### SUMMARY

Object of the disclosure: an object of the disclosure is to provide a fan lamp with a blade arm assembly, which solves a problem of unstable connection of blade arms of a ceiling fan.

Technical scheme: a fan lamp with a blade arm assembly includes a mounting base, and a connecting member that is ring-shaped and has a hollow center. A plurality of blade arms are inserted into the mounting base, and each of the plurality of blade arms is connected with a respective blade, and the connecting member and the plurality of blade arms are detachably connected with each other.

Preferably, a connecting groove upwardly opened is provided in the connecting member, and the connecting member is detachably connected with the blade arm at a bottom wall of the connecting groove.

Preferably, the connecting member includes a plurality of arc-shaped pieces which are connected end to end, and one end of each of the plurality of arc-shaped pieces is provided with a connecting block. The connecting block of one arc-shaped piece is clamped with the other end of another arc-shaped piece.

The connecting member is in a form of combined multiple pieces, which facilitates storage and disassembly and assembly and reduces a transportation space.

Preferably, a number of the plurality of arc-shaped pieces is less than a number of the plurality of blade arms.

The connecting member formed by the combined arc-shaped pieces may connect all of the plurality of blade arms, and when the number of arc-shaped pieces is less than the number of the blade arms, the blade arms may not be in one-to-one correspondence with the arc-shaped pieces, and connection strength between the arc-shaped pieces can be improved to avoid falling off.

Preferably, the connecting member is in a circular ring shape, and the connecting member and any of the plurality of blade arms can be detachably connected with each other.

Preferably, the blade arm is provided with a plug-in part, and the plug-in part is inserted into the mounting base.

Preferably, an upper side of the mounting base is connected with a motor, and an outer side of the motor is connected with a motor cover.

A fan lamp includes the fan lamp with the blade arm assembly described above, and a light-emitting module is rotatably mounted at a lower end of the mounting base.

The disclosure has advantages that connection strength between the blade arm and the mounting base is improved through insertion of the blade arm into the mounting base, and the plurality of blade arms surrounding a periphery of the mounting base are connected together through the connecting member, so that the blade arms, the mounting base and the connecting member are combined to form a new plane, which are integrated and is more difficult to fall off with ensured connection strength.

### BRIEF DESCRIPTION OF THE DRAWINGS

FIG. 1 is a schematic view of an overall structure according to the disclosure;

FIG. 2 is an overall exploded view according to the disclosure;

FIG. 3 is a schematic structural view of a blade arm according to the disclosure;

FIG. 4 is a schematic view of a mounting structure of a connecting member according to the disclosure; and

FIG. 5 is a schematic structural view of a connecting member according to the disclosure.

Reference Numerals: 11. Blade; 12. Blade Arm; 121. Connecting Part; 122. Plug-in Part; 13. Connecting member; 131. Connecting Member; 132. Arc-shaped Piece; 133. Connecting Groove; 14. Motor Cover; 15. Mounting Base; 16. Light-Emitting Module; 17. Motor; 18. Shaft Body; 19. Mounting Boom; 20. Back Cover.

### DETAILED DESCRIPTION

In order to make technical schemes of the disclosure more clear, the disclosure will be further explained in detail in the following in combination with drawings and specific examples.

### Embodiment 1

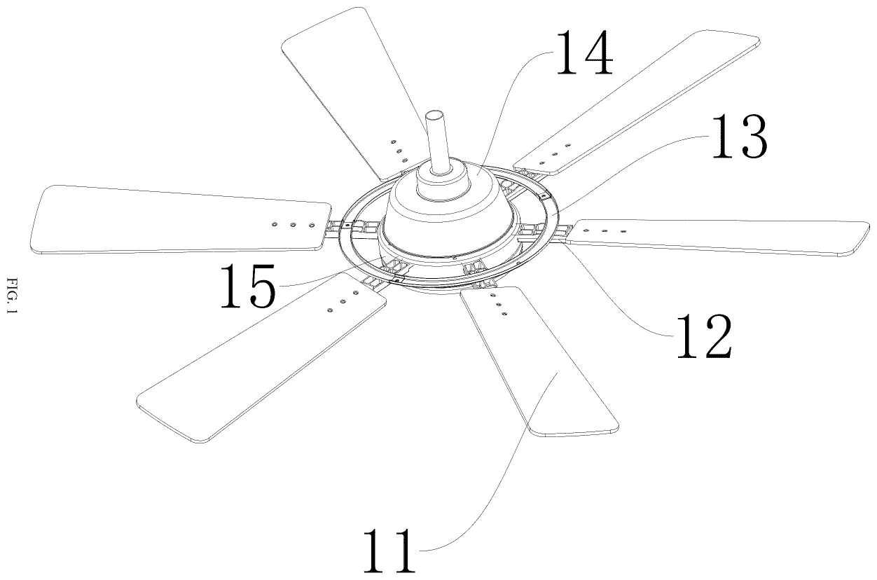

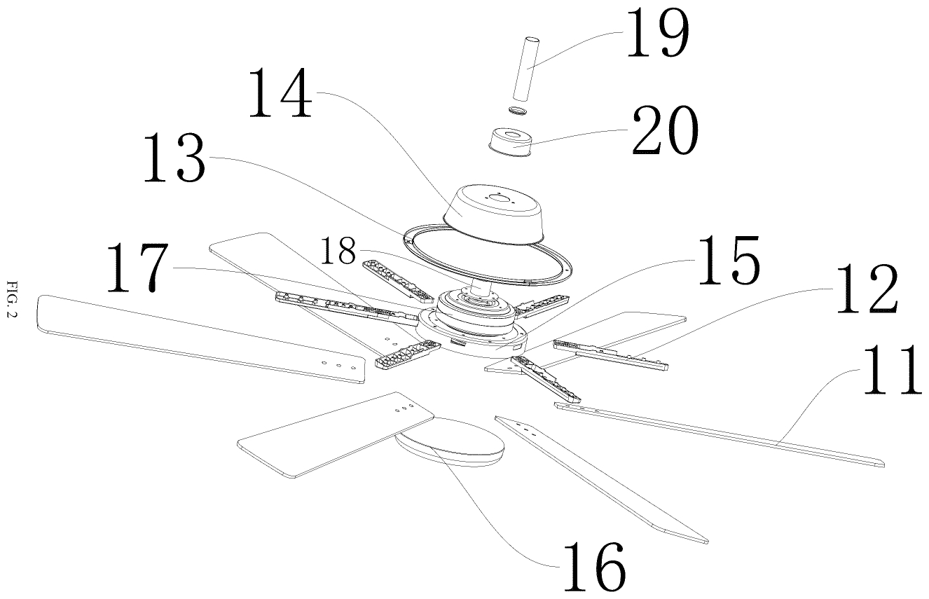

As shown in FIG. 1 and FIG. 2, a fan lamp with a blade arm assembly include a mounting base 15, and the mounting base 15 is a metal disk with a clamping groove and operates as a connecting base. An upper end of the mounting base 15 is provided with a motor 17, and the motor 17 is provided with a shaft body 18 penetrating through the motor 17. The motor 17 is fixedly connected with the mounting base 15 through the shaft body 18, and a motor cover 14 is also provided above the motor 17, and the motor cover 14 is sleeved and fixed from top to bottom. Meanwhile, there is further provided a mounting boom 19 above the motor cover. A back cover 20 is sleeved on the mounting boom 19 and inserted into the sleeve, and fixed by bolts and screws. The mounting boom 18 enables this device to be mounted on a ceiling.

A light-emitting module 16 is installed below the mounting base 15, and the light-emitting module 16 is rotatably mounted below the mounting base 15. The mounting base 15 and the light-emitting module 16 are fixedly connected. When the ceiling fan operates, the light-emitting module 16 does not rotate, which does not affect normal light-emitting operations. The light-emitting module 16 includes a hood, a base, a lamp board, a terminal connecting wire and other devices, in which the lamp board, as a light source, adopts an aluminum substrate to facilitate heat dissipation, and the light source adopts a layout of two or more color temperature of LEDs.

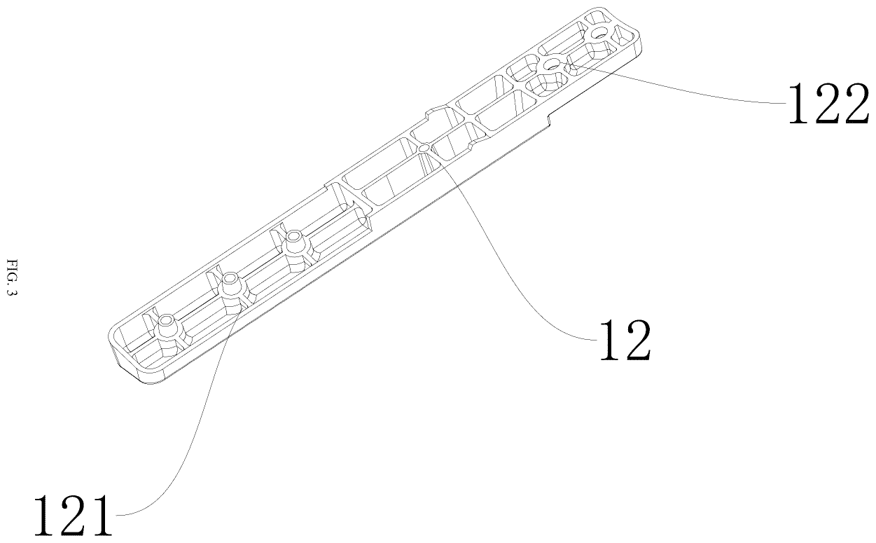

As shown in FIG. 2 and FIG. 3, the mounting base 15 is further connected with a blade arm 12, and the blade arm 12 is further connected with a blade 11. The blade arm 12 is detachably connected with both the mounting base 15 and the blade 11. One end of the blade arm 12 is a plug-in part 122, and a plug-in hole is provided at a side wall of the mounting base 15, and the plug-in part 122 of the blade arm 12 is inserted into the plug-in hole, and then connected and fixed by bolts, while the other end of the blade arm 12 is a connection part 121. The connecting part 121 and the blade 11 are directly connected through bolts, thus realizing fixing effect.

In this disclosure, the blade arm 12 is made of metal to ensure its connection strength, while the blade 11 is made of wood, which is firmly mounted with the blade arm 12 to ensure safety.

After the blade arm 12 is connected with the mounting base 15, the blade arm 12 is fixed for the second time, so as to ensure that the blade arm 12 is more stable. In this disclosure, the fan lamp further includes a connecting member 13, and the connecting member 13 has a cavity penetrating up and down, and the connecting member 13 has a closed curved-surface structure and can be polygonal. Regarding this, a number of sides of the polygon is the same as that of blade arms 12, and the blade arms 12 correspond to edges or corners of the connecting member 13 one by one, which facilitates positioning and connection. In this disclosure, the number of the blade arms 12 is not limited, and can be adjusted according to actual use requirements, and then when the connecting members 13 are replaced with a same number of polygons as that of the blade arms 12, mounting operations can be carried out correspondingly.

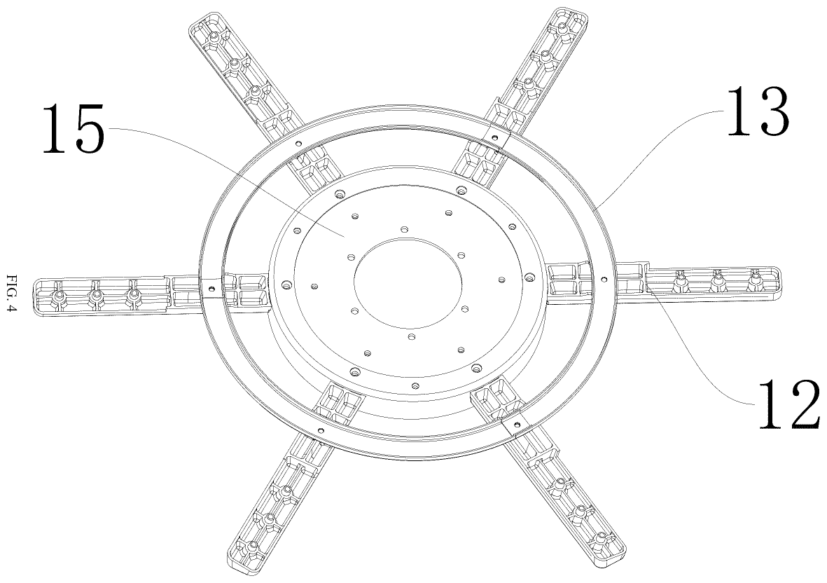

In this embodiment, the connecting member 13 can also be in a circular ring shape, and there is no need to specifically replace the connecting member for the blade arms 12. When the number of the blade arms 12 varies, the connecting member 13 can be directly connected without adjustment, as shown in FIG. 4.

Meanwhile, a connecting groove 133 upwardly opened is provided on an upper end face of the connecting member 13, the connecting groove 133 is in a circular ring shape and covers the whole connecting member 13. When the connecting member 13 is connected with the blade arm 12, bolts are placed within the connecting groove 133, and connecting operations of the connecting member 13 and the blade arms 12 are made at a bottom wall of the connecting groove 133, and the connecting member and the blade arms are connected at the bottom of the connecting groove 133, so that the bolts and nuts can be prevented from falling outside and affecting the mounting operations.

When the connecting member 13 is connected with all of the blade arms 12, all of the blade arms 12, the connecting member 13 and the mounting base 15 are in a same plane, thus with higher connection strength, and the blade arms 12 are connected with each other, which are less likely to fall off, and the number of the blade arms 12 is at least three, so that stability can be ensured when the blade arms 12 and the connecting member 13 are connected with each other.

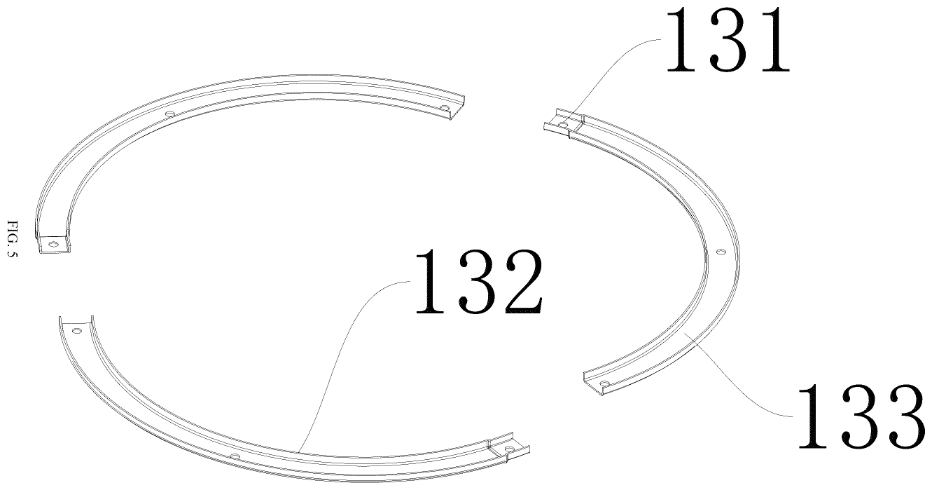

As shown in FIG. 5, in the above embodiment, further, the connecting member 13 is integrally formed. In another embodiment, the connecting member 13 can be composed of a plurality of arc-shaped pieces 132 combined with other, a connecting groove 133 upwardly opened is also defined in an arc-shaped piece 132. One end of the arc-shaped piece 132 is provided with a connecting block 131, and a plurality of arc-shaped pieces 132 are connected end to end, and the connecting block 131 of the arc-shaped piece 132 can be connected with the connecting groove 133 at the other end of another arc-shaped piece 132. The arc-shaped pieces 132 can be combined with each other by clamping, thus forming a circular ring shape, which can be connected with the blade arms 12.

Moreover, when the connecting member 13 is composed of the plurality of arc-shaped pieces 132 combined with each other, the number of the arc-shaped pieces 132 needs to be less than the number of the blade arms 12, so as to prevent one-to-one connection of the blade arms 12 and the arc-shaped pieces 132, which causes reduction in fixing effect.

The above described embodiments only express several implementations of the present disclosure, and their descriptions are more specific and detailed, but they cannot be constructed as limiting a scope of the present disclosure. It should be noted that, several modifications and improvements can be made by those of ordinary skill in the art without departing from the concept of the present disclosure, which belong to the protection scope of the present disclosure. Therefore, the protection scope of this disclosure shall be subjected to appended claims.

1. A fan with a blade arm assembly, comprising: a mounting base, and a connecting member that is ring-shaped and has a hollow center, wherein a plurality of blade arms is inserted into the mounting base, and each of the plurality of blade arms is connected with a respective blade, and the connecting member and the plurality of blade arms are detachably connected with each other;
wherein a connecting groove upwardly opened is provided in the connecting member, and the connecting member is connected with the blade arm at a bottom wall of the connecting groove: wherein the connecting member comprises a plurality of arc-shaped pieces which are connected end to end, the connecting groove upwardly opened is also provided in the plurality of arc-shaped pieces, and one end of each of the plurality of arc-shaped pieces is provided with a connecting block, and the connecting block of one arc-shaped piece is detachably connected with the connecting groove at the other end of another arc-shaped piece; the plurality of arc-shaped pieces combined with each other, the connecting member is in a circular ring shape;
wherein the blade arm is provided with a plug-in part, and the plug-in part is inserted into the mounting base, when the connecting member is connected with all of the blade arms, all of the blade arms, the connecting member and the mounting base are in a same plane.

2. (canceled)

3. (canceled)

4. The fan with the blade arm assembly according to claim 3, wherein a number of the plurality of arc-shaped pieces is less than a number of the plurality of blade arms.

5. (canceled)

6. (canceled)

7. (canceled)

8. The fan with the blade arm assembly according to claim 1, wherein an upper side of the mounting base is connected with a motor, and an outer side of the motor is connected with a motor cover.

9. A fan lamp, comprising the fan with the blade arm assembly according to claim 1, a light-emitting module being rotatably mounted at a lower end of the mounting base.

10. (canceled)

11. (canceled)

12. A fan lamp, comprising the fan with the blade arm assembly according to claim 4, a light-emitting module being rotatably mounted at a lower end of the mounting base.

13. (canceled)

14. (canceled)

15. (canceled)

16. A fan lamp, comprising the fan with the blade arm assembly according to claim 8, a light-emitting module being rotatably mounted at a lower end of the mounting base.
